(19) United States
(12) Patent Application Publication
(10) Pub. No.: US 2008/0130058 A1
(43) Pub. Date: Jun. 5, 2008

(54) METHOD OF PROTECTING DIGITAL DATA BY UTILIZING AN EMBEDDED WATERMARK

(76) Inventor: Chi-Chen CHENG, Taipei (TW)

Correspondence Address: SINORICA, LLC, 528 FALLSGROVE DRIVE, ROCKVILLE, MD, 20850, US

(21) Appl. No.: 11/566,245

(22) Filed: Dec. 4, 2006

(51) Int. Cl. G06K 15/00

(52) U.S. Cl. 358/3.28

(57) ABSTRACT

A method of protecting digital data by embedding a watermark in the digital data is discloses. The watermark identifies a specific user who originally downloaded the digital data. The watermark comprises data that when read reveals a user's account information, a user identifier, a user's real name, a data identifier, a content provider identifier, a device identifier, or a combination of these. Since any copies of the digital data contain the original download user's watermark, users will not allow the digital data to be illegally copied or shared as the original user can be punished or prosecuted for unauthorized sharing of the digital data. The method effectively and efficiently protects digital data without the need for cumbersome digital rights management system.

### BACKGROUND OF THE INVENTION

1. Field of the Invention

The present invention relates to digital data protection. More specifically, the present invention discloses a method of protecting digital data such as multimedia content that utilizes a watermark to identify individual users and content in order to prevent illegal copying of the digital data.

2. Description of the Prior Art

Accessing digital multimedia via the Internet is becoming more popular as bandwidth increases. Users can visit a content provider's website and download multimedia such as movies or music.

In order to protect their content a content provider will typically use a type of digital rights management (DRM). DRM is a technique used to control access and usage of digital data. Typically DRM will restrict usage to a single instance of the data or a single device.

While DRM works fairly well for content providers the technology is annoying for users. For example, if a particular song is purchased by a user and downloaded to user's device A it cannot be transferred and listened to on user's device B even though the song has been legally purchased.

Additionally, some forms of DRM can be considered anti-competitive as they require the user to use a particular device, file type, or content. For example, a song with a DRM can only be played on one brand of portable music player. This is inconvenient to users as it forces the user to use a particular device rather than choosing to use a device that the user wants to use.

Furthermore, some types of DRM have been successfully defeated by hackers. As a result the digital data can be shared without authorization using popular file sharing tools. This prevents content owners from receiving their deserved profit.

Therefore, there is need for an improved method of protecting digital data that prevents illegal copying and sharing but is not obtrusive or annoying to users.

### SUMMARY OF THE INVENTION

To achieve these and other advantages and in order to overcome the disadvantages of the conventional method in accordance with the purpose of the invention as embodied and broadly described herein, the present invention provides a method of protecting digital multimedia content that utilizes a watermark to identify individual users and multimedia content in order to prevent illegal copying of the multimedia content.

The method of the present invention comprises embedding a digital watermark or electronic fingerprint in digital data. The watermark identifies the user who downloaded the digital data. If unauthorized copying or sharing of the data is discovered the original user can easily be identified and punished.

In the present invention a content provider supplies multimedia content that is available for download by registered users. The content comprises music, video, games, software, electronic books, or other types of digital data. A user signs up for the service and creates a user account. Once the user logs into the user account the user can begin downloading the data.

When the data has been successfully downloaded to a user device the method of the present invention embeds a watermark into the data. The watermark comprises a user's account information, a user identifier, a user's real name, a data identifier, a content provider identifier, a device identifier, or a combination of these.

Since the user submitted information during the registration process the user can easily be identified. The user provides information such as, for example, user name, address, telephone number, contact information, age, gender, payment method, payment means, etc.

If an unauthorized copy of the digital data is discovered the watermark can be read and the original user can be identified. If the digital data was illegally shared by the original user can be punished. For example the identity of the user can be turned over to the proper authorities for prosecution or the user's account can be terminated.

As a result user's protect their digital data and will not share the data in an authorized manner. Therefore, piracy of the digital data is eliminated.

If the watermark comprises a data identifier the data can be identified regardless if the name of the data file has been changed. This renders renaming of the data file in order to hide the actual data contents useless.

If the watermark comprises a content provider identifier the original content provider or content owner can be identified.

The method of the present invention is most suitable for music or video download services. However, the method can be applied to any type of service that provides downloadable data.

Since the method of the present invention prevents unauthorized copying of digital data, content provider's profits increase and the digital data can be provided at a lower cost to users. This has the effect of making the service more popular.

An advantage of the present invention is that users protect their digital data rather than requiring the content provider to try to protect the data once it is out of the content provider's control. The method is much more effective making it easier to control protection of the digital data.

These and other objectives of the present invention will become obvious to those of ordinary skill in the art after reading the following detailed description of preferred embodiments.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention. In the drawings:

FIG. 1 is a drawing illustrating flow and architecture of a system and method for protecting digital data that utilizes a watermark to identify individual users and data in order to prevent illegal copying of the data according to an embodiment of the present invention;

FIG. 2 is a flowchart illustrating a method for protecting digital data according to an embodiment of the present invention;

FIG. 3 is a flowchart illustrating a method of protecting digital data according to an embodiment of the present invention;

FIG. 4 is a flowchart illustrating a method of protecting digital data according to an embodiment of the present invention;

FIG. 5 is a flowchart illustrating a method of protecting digital data according to an embodiment of the present invention; and

FIG. 6 is a flowchart illustrating a method of protecting offline digital data according to an embodiment of the present invention.

### DESCRIPTION OF THE PREFERRED EMBODIMENTS

Reference will now be made in detail to the preferred embodiments of the present invention, examples of which are illustrated in the accompanying drawings. Wherever possible, the same reference numbers are used in the drawings and the description to refer to the same or like parts.

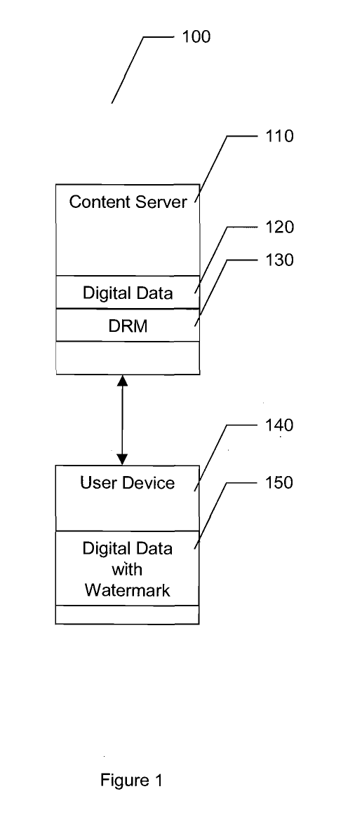

Refer to FIG. 1, which is a drawing illustrating flow and architecture of a system and method for protecting digital data that utilizes a watermark to identify individual users and data in order to prevent illegal copying of the data according to an embodiment of the present invention.

As shown in FIG. 1, a system 100 utilizing the method of the present invention comprises a content provider server 110 on which digital data 120 is stored. The digital data 120 comprises music, video, games, software, multimedia, or other types of digital data. In an embodiment of the present invention the digital data is protected by DRM 130.

Initially a user registers with the content provider in order to utilize the content provider's services. During registration the user supplies personal information. The personal information comprises, for example, user name, real name, address, telephone number, contact information, age, gender, payment method, payment means, payment information, password, or other information that identifies the user.

After registration is complete the user logs in by supplying their user name and password. When the user is logged in the user can browse through the website and select various files of digital data 120 to download.

When the digital data has been successfully downloaded to the user's electronic device 140, for example, a computer, notebook computer, PDA, or cellular phone, a watermark or digital fingerprint is embedded into the digital data 150. The watermark comprises data that identifies the user who originally downloaded the digital data. For example, in an embodiment of the present invention the watermark comprises the user name of the user who downloaded the digital data.

When a copy of the digital data is discovered, the watermark is read and the user is identified. Copies can be discovered on pier-to-pier networks, bit torrent networks, or other file sharing networks. Once the user is identified the evidence can be turned over to the proper authorities for prosecution or punishment or the content provider can be notified and the user's account can be suspended or terminated.

Since the digital data comprises the embedded watermark which identifies the user, the user will be extremely cautious with the digital data. A user will not let the digital data get out of their immediate control. For example, a user will not allow the digital data with the watermark to be shared on a file sharing network as this would result in punishment to the user.

Utilizing the method of the present invention users will treat their digital data similar to how they treat their credit cards. A user wouldn't allow their credit card to be used by others as it could destroy their credit. In the same way with the present invention a user won't allow their digital data to be copied and shared by others as the copy will carry their identity. If multiple copies of the digital data appear on a file sharing network the original user faces severe consequences. As a result users are very protective of their digital data.

In other embodiments of the present invention the watermark or digital fingerprint comprises a user's account information, a user identifier, a user's real name, a data identifier, a content provider identifier, a device identifier, or a combination of these.

For example, in embodiments where the watermark comprises a content provider identifier the content provider is easily identified.

In an embodiment of the present invention the DRM is removed from the digital data prior to embedding the watermark. This removes any potential conflict between the DRM and the user's devices.

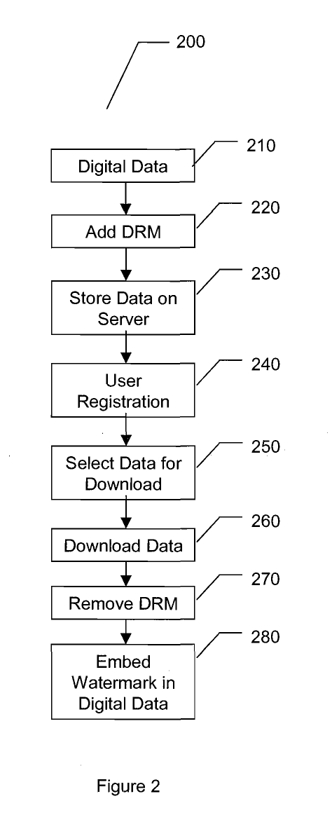

Refer to FIG. 2, which is a flowchart illustrating a method for protecting digital data according to an embodiment of the present invention.

The method 200 illustrated in FIG. 2 comprises providing digital data for download in Step 210. DRM protecting the digital data in Step 220 and storing the DRM protected digital data on a content server in Step 230. A user registers with the content provider's service in Step 240 by supplying personal information. Once registered the user selects digital data to download in Step 250 and the digital data is downloaded in Step 260. When the digital data has been successfully downloaded to the user's device the DRM is removed in Step 270 and a watermark identifying the user is embedded in the digital data in Step 280.

Anytime the digital data is copied or transferred to another device, the watermark remains embedded in the digital data. The watermark in any copies of the digital data can be read and the user is identified. This prevents users from illegally copying or sharing the digital data.

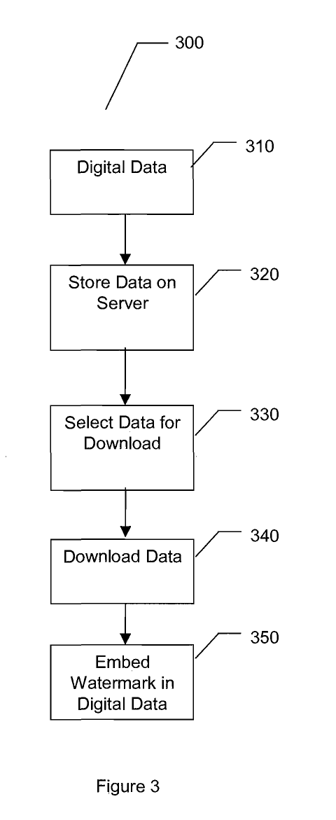

Refer to FIG. 3, which is a flowchart illustrating a method of protecting digital data according to an embodiment of the present invention. The method 300 comprises providing digital data 310 and storing the digital data on a server 320. A registered user selects data for download 330 and the digital data is downloaded to the user's device 340. A watermark is embedded into the digital data identifying the user who downloaded the data.

In this embodiment's method the digital data stored on the content server is not protected by DRM. The content provider stores digital data for download on the content server. A registered user selects digital data files to download and the digital data is downloaded.

After the digital data has been downloaded a watermark is embedded into the digital data. The watermark comprises data that identifies the user who downloaded the digital data. Any copies of the digital data will have the embedded watermark identifying the user.

In this embodiment DRM is not used and doesn't need to be removed. However, the digital data is still protected since it contains a watermark identifying the user. This allows the content provider's data to be protected while being unobtrusive or annoying to users.

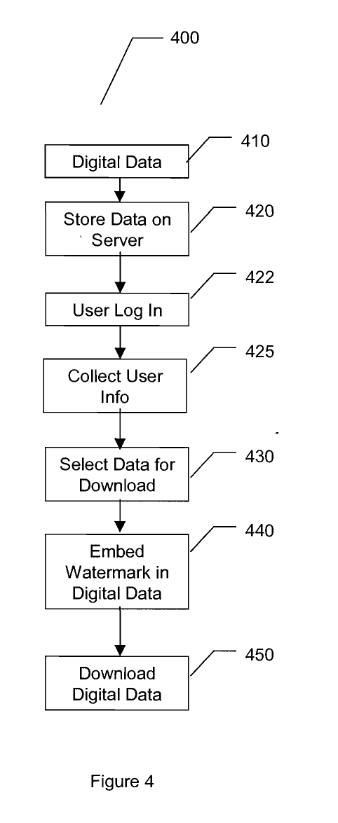

Refer to FIG. 4, which is a flowchart illustrating a method of protecting digital data according to an embodiment of the present invention. In this embodiment's method 400 the watermark is embedded by the content provider. The content provider provides digital data 410 and stores the data on a server 420. A user logs into the server 422 and the server collects or retrieves the user's information 425. When the registered user selects a digital data file to download 430, the watermark is embedded into the digital data prior to download 440. This watermark is personalized according to the user's information or identification so that each user is uniquely identifiable. Once the watermark is embedded the digital data is downloaded to the user's device 450.

This method provides extreme security for the content provider. There is no need for DRM in this embodiment. The watermark comprises characteristics that identify the user who is downloading the data. Therefore any copies of the digital data can be identified by reading the watermark.

Since the watermark identifies the original downloading user, the user will not allow the digital data to be copied or shared due to the risk of prosecution or punishment. In this way, the method of the present invention efficiently and effectively protects digital data and prevents illegal or unauthorized copying and sharing of the digital data. At the same time the method is user friendly and users are not annoyed by device or playback conflicts.

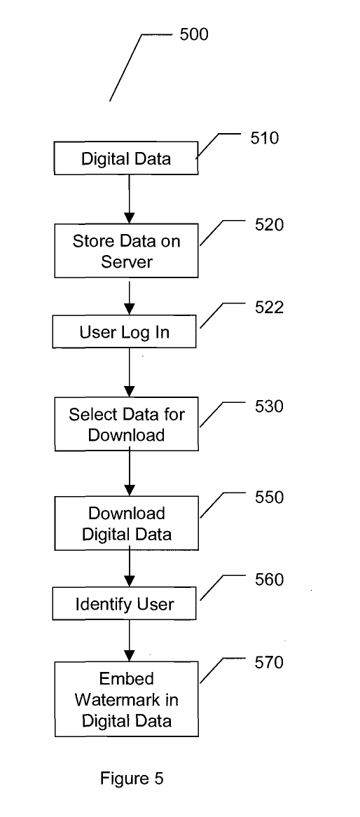

Refer to FIG. 5, which is a flowchart illustrating a method of protecting digital data according to an embodiment of the present invention.

In this embodiment the content provider provides digital data 510 and stores the data on a server 520. A registered user logs onto the server 522 and browses through the available digital data. The user selects digital data that they wish to download 530. The digital data is then downloaded to the user's electronic device 550. The user is identified to uniquely determine the user's identity 560 and a watermark is created and embedded in the digital data based upon the user's identity 570. In this embodiment the user's identity is stored on the electronic device that was used for downloading the digital data. For example, the user's identity is determined by examination of a cookie, a dongle, a personalized identification device, a removable storage medium, a hardware key, a license, device identification, digital file, executable file, stored data, password, biometric data, biometric characteristic, or dynamic link library file.

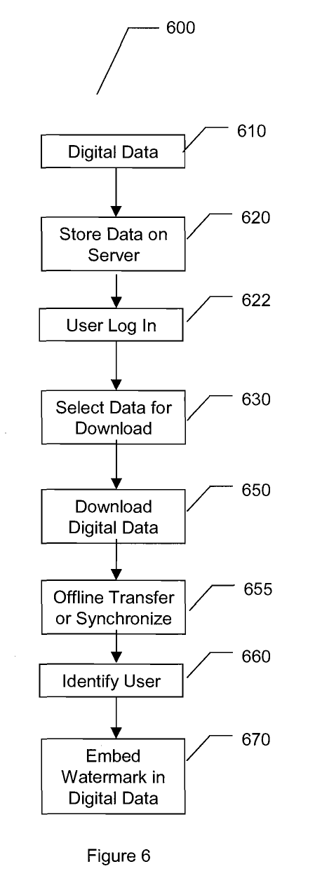

Refer to FIG. 6, which is a flowchart illustrating a method of protecting offline digital data according to an embodiment of the present invention.

The embodiment illustrated in FIG. 6 is similar to the embodiment of FIG. 5 but in this embodiment the watermark is embedded into the digital data whenever the data is transferred to another device, copied, converted to another format, recorded onto a compact disk or DVD, or synchronized to a portable device. When a user chooses any of these operations 655 the identity of the user is determined 660 and the watermark is embedded in the digital data 670. In an embodiment the watermark is embedded prior to performing the operation. For example, if the original digital data is an .mp3 file, when the file is burnt onto a compact disk as an audio file the watermark is embedded into the audio file on the compact disk.

In FIG. 6 the watermark is embedded when the user's electronic device is offline or disconnected from the Internet. This provides protection for the digital data when the device where the data is stored is not on-line.

In an embodiment of the present invention the watermark is embedded in a plurality of locations within the digital data. In this way, even if the data file is divided into multiple sections the watermark is still present in each section. This prevents unauthorized copying of large files such as video files.

In an embodiment of the present invention the watermark comprises audio data that doesn't interfere with the audio of the digital data. For example, the watermark can be above or below human hearing levels.

It will be apparent to those skilled in the art that various modifications and variations can be made to the present invention without departing from the scope or spirit of the invention. In view of the foregoing, it is intended that the present invention cover modifications and variations of this invention provided they fall within the scope of the invention and its equivalent.

What is claimed is:

1. A method of protecting digital data comprising:
embedding a watermark in digital data, the watermark identifying a user who downloaded the digital data.

2. The method of protecting digital data of claim 1, the watermark comprising a user's account information, a user identifier, a user's real name, a data identifier, a content provider identifier, a device identifier, or a combination of these.

3. The method of protecting digital data of claim 1, the watermark comprising data that when read reveals a user's account information, a user identifier, a user's real name, a data identifier, a content provider identifier, a device identifier, or a combination of these.

4. The method of protecting digital data of claim 1, the watermark being embedded prior to downloading of the digital data.

5. The method of protecting digital data of claim 1, the watermark being embedded after the digital data has been downloaded to a user's device.

6. The method of protecting digital data of claim 1, further comprising:
removing digital rights management protection from the digital data prior to embedding the watermark.

7. The method of protecting digital data of claim 1, further comprising:
reading the watermark to determine which user originally downloaded the digital data.

8. The method of protecting digital data of claim 1, further comprising:
notifying proper authorities of unauthorized copying of the digital data.

9. The method of protecting digital data of claim 1, further comprising:
notifying a content provider of unauthorized copying of the digital data downloaded from the content provider.

10. The method of protecting digital data of claim 9, further comprising:
suspending or terminating a user's account if unauthorized copying of the digital data is discovered.

11. A method of protecting digital data comprising:
removing digital rights management protection from digital data; and
embedding a watermark in the digital data, the watermark identifying a user who downloaded the digital data.

12. The method of protecting digital data of claim 11, the watermark comprising a user's account information, a user identifier, a user's real name, a data identifier, a content provider identifier, a device identifier, or a combination of these.

13. The method of protecting digital data of claim 11, the watermark comprising data that when read reveals a user's account information, a user identifier, a user's real name, a data identifier, a content provider identifier, a device identifier, or a combination of these.

14. The method of protecting digital data of claim 11, the watermark being embedded prior to downloading of the digital data.

15. The method of protecting digital data of claim 11, the watermark being embedded after the digital data has been downloaded to a user's device.

16. The method of protecting digital data of claim 11, further comprising:
reading the watermark to determine which user originally downloaded the digital data.

17. The method of protecting digital data of claim 11, further comprising:
notifying proper authorities of unauthorized copying of the digital data.

18. The method of protecting digital data of claim 11, further comprising:
notifying a content provider of unauthorized copying of the digital data downloaded from the content provider.

19. The method of protecting digital data of claim 18, further comprising:
suspending or terminating a user's account if unauthorized copying of the digital data is discovered.

20. A method of protecting digital data comprising:
embedding a watermark in digital data which identifies a specific user who downloaded the digital data.
